(19) United States
(12) Patent Application Publication
(10) Pub. No.: US 2004/0214885 A1
(43) Pub. Date: Oct. 28, 2004

(54) Ferrous bisglycinate hydrochloride

(76) Inventors: Brent P. Hagen, Brigham City, UT (US); Wayne E. White, Thousand Oaks, CA (US); Shane R. Shupe, Harrisville, UT (US)

Correspondence Address: Thompson E. Fehr, Goldenwest Corporate Center, 5025 Adams Avenue, Suite 300, Ogden, UT, 84403, US

(21) Appl. No.: 10/425,205

(22) Filed: Apr. 28, 2003

(51) Int. Cl. C07F 15/02

(52) U.S. Cl. 514/476; 556/148

(57) ABSTRACT

A hydrochloride salt of ferrous bisglycinate having the formula Fe(C₂H₄NO₂.HCl)₂, which is highly soluble in water, making the compound beneficial as a dietary supplement. One form of the commercial product of the compound has the ferrous bisglycinate hydrochloride dissolved in water.

### BACKGROUND OF THE INVENTION

1. Field of the Invention

This invention relates to a compound for incorporating iron within an animal, including a human being.

2. Description of the Related Art

Six patents are known to disclose iron amino acid chelates. These are U.S. Pat. Nos. 5,504,055; 5,516,925; 5,534,275; 6,159,530; 6,197,815; and 6,207,204. Such compounds are, however, distinct from that of the present invention.

### BRIEF SUMMARY OF THE INVENTION

The compound that is the subject of the present invention is the hydrochloride salt of ferrous bisglycinate, which has been determined to be highly soluble in water, thereby making the compound beneficial as a dietary supplement.

### DETAILED DESCRIPTION OF THE INVENTION

The compound of the present invention is ferrous bisglycinate hydrochloride.

The formula for this compound is Fe(C₂H₄NO₂.HCl)₂.

Since it is highly soluble in water, it is, as mentioned above, beneficial as a dietary supplement. Also, it is convenient, but not necessary, to dissolve the compound in water in order to create a commercial form of the compound.

Examples of methods for making the ferrous bisglycinate hydrochloride are as follows:

### EXAMPLE 1

1 mole ferrous chloride was dissolved in an equal weight of water. 2 moles glycine were added such solution and dissolved with the addition of heat. The resulting product was dried.

### EXAMPLE 2

1 mole ferrous chloride was dissolved in sufficient water to make a 50 percent, by weight, solution. 2 moles glycine were dissolved in sufficient water to make a 59 percent, by weight, solution. These two solutions were mixed, and the resulting product was dried.

We claim:

1. A composition of matter having the formula:
Fe(C₂H₄NO₂.HCl)₂.

2. The composition of matter of claim 1, further comprising: water in which the Fe(C₂H₄NO₂.HCl₂) has been dissolved.
